(19) United States
(12) Patent Application Publication
(10) Pub. No.: US 2006/0255888 A1
(43) Pub. Date: Nov. 16, 2006

(54) Radio-frequency filter

(75) Inventor: Ingo Mayr, Niederndorf (AT)

Correspondence Address: NIXON & VANDERHYE, PC, 901 NORTH GLEBE ROAD, 11TH FLOOR, ARLINGTON, VA, 22203, US

(73) Assignee: Kathrein Austria Ges.m.b.H, Kufstein (AT)

(21) Appl. No.: 11/128,436

(22) Filed: May 13, 2005

(51) Int. Cl. H01P 7/04

(52) U.S. Cl. 333/223; 333/134

(57) ABSTRACT

An improved coaxial radio-frequency resonator comprises the following features:
the stabilization and/or compensation device (17) has a device (19) which is in the form of or is similar to a bimetallic strip and it deforms as a function of temperature, and
the stabilization and/or compensation device (17) has and/or is fitted directly or indirectly with a capacitance changing device (21), which has at least one electrically conductive section, at least one dielectric section or at least both, and
the capacitance changing device (21) is arranged in the interior (3) of the resonator (1).

The invention relates to a coaxial radio-frequency filter according to the precharacterizing clause of claim 1.

A common antenna is frequently used for transmission and received signals in radio systems, in particular in the mobile radio field. In this case, the transmission or received signals each use different frequency ranges, and the antenna must be suitable for transmission and reception in both frequency ranges. Suitable frequency filtering is therefore required to separate the transmission and received signals, by means of which on the one hand the transmission signals are passed on from the transmitter to the antenna and, on the other hand, the received signals are passed on from the antenna to the receiver. The transmission and received signals are nowadays separated, inter alia, by means of coaxial radio-frequency filters.

Coaxial radio-frequency filters have coaxial resonators in which resonator cavities are formed in an outer conductor housing, with inner conductors in the form of inner conductor tubes being arranged in the resonator cavities. The inner conductor tubes each have a free end which is located adjacent to a cover that is arranged on the upper face of the housing. When temperature fluctuations occur, this results in a change in the mechanical length of the inner conductor tube. As can be seen from the formula λ=c/f (where λ is the mechanical length of the inner conductor of the coaxial radio-frequency filter, c is the speed of light and f is the frequency), the mechanical length is inversely proportional to the frequency, so that the resonant frequency of the filter falls when the mechanical length decreases as the temperature rises.

This dominant effect leads, for example in the case of a filter with a resonant frequency of 1 GHz, to a resonant frequency change by 1 MHz when a temperature difference of 40° C. occurs.

A further, second effect occurs in the event of temperature changes. A capacitance (so-called head capacitance) is formed between the cover and the inner conductor tube at the free end of the inner conductor. This capacitance also governs the frequency. When a temperature increase occurs, the inner conductor tube and the walls of the outer conductor housing expand by the same factor. Since the walls of the outer conductor housing are higher than the inner conductor tube, this results in an increase in the distance between the inner conductor tube and the cover, which results in a decrease in the head capacitance and leads to an increase in the resonant frequency. This effect thus counteracts the reduction in the resonant frequency resulting from the greater mechanical length of the inner conductor tube when temperature increases occur. However, the effect is very minor and is not significant.

In order to increase the effect of the decrease in the head capacitance when temperature increases occur, it is known from the prior art for parts of the inner conductor tube or else the entire inner conductor to be manufactured from a different material with a lower thermal coefficient of expansion than the outer conductor housing. In consequence, when a temperature increase occurs, the head capacitance becomes even smaller and compensates for the effect of the frequency increase resulting from the temperature-dependent length expansion. Filters such as these allow temperature compensation to be achieved such that the resonators in the filter have a constant resonant frequency in a specific temperature range. However, this type of compensation has a number of disadvantages. Since the inner conductor or parts of the inner conductor is or are composed of a different material to that of the housing, a disturbance point always occurs between two materials, even if the two are soldered to one another. Apart from manufacturing problems, this can also cause intermodulation problems.

Furthermore, two or more different materials must be joined together in the resonator space, which is critical to the radio frequency, in which case mechanical tolerances in this space may have serious influences on the filter. If, by way of example, an inner conductor is not positioned accurately in the filter to within a few hundredths of a millimeter, the coupling bandwidth to all of the adjacent resonators changes, which can in turn result in tuning problems. In addition, a large amount of time is required for optimization in the filter development phase since a specific compensation element must be developed for virtually each inner conductor. Furthermore, in large-scale production, this results in a large number of various different parts which have to be joined together, thus making the assembly process more difficult. In particular, this can lead to confusion during the assembly process, and special tools must be used during the assembly process. This also increases the filter price.

The document U.S. Pat. No. 6,407,651 B1 discloses a radio-frequency filter of this generic type in which a compensation element is used which is fitted to the inner conductor tube and is connected via a bellows to the upper face of the inner conductor tube. The position of the compensation element can be varied by means of an adjusting screw. Temperature compensation can be provided for the filter by using different materials for the compensation element and for the screw.

One object of the present invention is to provide a coaxial radio-frequency filter which is better than the prior art, is of simple design and is simple to manufacture, and at the same time has an optimum capability to vary the resonant frequency setting, in particular in the form of temperature compensation for stabilization of the resonant frequency.

According to the invention, the object is achieved with respect to the RF resonator on the basis of the features specified in claim 1. Advantageous refinements of the invention are specified in the dependent claims.

The coaxial radio-frequency filter according to the invention comprises a device of very simple design but which is nonetheless highly effective for stabilization and for maintenance of a resonant frequency, that is to say in particular a temperature compensation device.

The stabilization and/or compensation device according to the invention in this case has a bimetallic strip, that is to say in particular an adjusting device which is in the form of or is similar to a bimetallic strip, and has at least two different materials, in particular at least two different metals with different coefficients of expansion. This leads to a temperature-dependent variation in the position and/or curvature of the bimetallic adjusting device, or of the adjusting device which is similar to a bimetallic strip, that is formed in this way. Furthermore, the invention also provides a capacitance changing device which is positioned in the interior of the coaxial radio-frequency filter. This capacitance changing device has at least one electrically conductive material section, at least one dielectric material section, or combinations of at least one metallic material section and at least one dielectric material section. This capacitance changing device now leads to the capacitance between the inner conductor and the housing or the cover of the outer conductor and/or the radio-frequency resonator in the interior of the coaxial radio-frequency filter being influenced.

In this case, the adjusting device, which is in the form of a bimetallic strip or a device which is similar to a bimetallic strip, has the object of varying the capacitance in the radio-frequency filter as a function of the capacitance by the temperature, so as to compensate for the effect described initially of the dimensional change, and thus of the frequency change, caused by thermal expansion. The material which is used and is in the form of a bimetallic strip or is in the form of the device which is similar to a bimetallic strip in this case has the capability to vary its shape as a function of the temperature.

The compensation device is positioned in the resonator such that it is located in the electrical field (E field) of the head capacitor described initially. In this case, it is irrelevant whether the compensation device is attached directly or indirectly to the housing, to the inner conductor or to the cover, etc.

The compensation device and/or the bimetallic adjusting device can thus be provided at widely differing points.

It is preferable for the compensation device to be arranged as far as possible in the area of high electrical field strengths because this is where a change in location or position leads to a greater compensation effect.

In one particularly preferred embodiment of the invention, the bimetallic adjusting device is likewise provided, positioned and mounted in the interior of the radio-frequency filter. By way of example, it may be mechanically anchored to the cover, to the housing or to the inner conductor. In one particularly preferred embodiment, the adjusting device which is in the form of or is similar to a bimetallic strip at the same time also represents the capacitance changing device since the bending of the adjusting device which is in the form of or is similar to a bimetallic strip at the same time also changes the capacitance, thus providing the temperature stabilization.

However, it is just as possible for the bimetallic adjusting device to be positioned outside the radio-frequency resonator housing, for example to be mechanically anchored on the outside of the cover and, in this case, a capacitance changing device which is physically separated from it is provided in addition to the adjusting device which is in the form of or is similar to a bimetallic strip. The actual compensation device is then connected directly or indirectly to the bimetallic adjusting device (which is provided outside the resonator) using a connecting device which, for example, is in the form of a physically thin rod, and is positioned in the interior of the radio-frequency resonator, via a hole in the housing or in the cover of the radio-frequency resonator. The compensation device which has been mentioned is then located in the interior of the radio-frequency resonator housing using, for example, at least one conductive or at least one dielectric material section. When the temperature of the bimetallic adjusting element changes, this likewise leads to a change in the location of the compensation device in the interior of the resonator, and thus to a change in the capacitance.

In another preferred embodiment of the invention, the bimetallic adjusting element at the same time also has the compensation device. In other words, the bimetallic adjusting element is arranged in the interior of the radio-frequency resonator so that its curvature, which varies as a function of the temperature, at the same time changes the electrical field between the inner conductor and the outer conductor, thus ensuring the desired temperature compensation in order to stabilize the resonant frequency even when the temperature changes.

Finally, it has likewise been found to be advantageous for the bimetallic adjusting element to be additionally provided with a conductive surface layer, for example composed of silver, in particular for positioning in the interior of the radio-frequency resonator. This layer may be chosen to be so thin that (at the frequencies which occur, for example in the GHz range) it ensures that the penetration depth of the current is so small that the current penetrates only into the surface layer and cannot penetrate into the area of the bimetallic strip. This further counteracts any possible Q-factor losses. Finally, the bimetallic adjusting device may also have further metallic layers, other layers or intermediate layers.

The principle according to the invention is thus overall based on the use of the adjusting or compensation device according to the invention to prevent, for example, the resonant frequency of the resonator falling when the temperature rises. In a situation such as this, the bimetallic strip or the bimetallic adjusting device would be deformed toward the cover when, for example, it is mounted on the lower face of the cover of the radio-frequency resonator, which would mean that the electrical field lines (E field lines) passing to the bimetallic strip would have to overcome a longer distance between the inner conductor and the cover, thus now resulting in a decrease in the head capacitance. This compensates for the effect of thermal expansion thus achieving the desired aim of the resonator oscillating approximately at the same resonant frequency in a temperature range of, for example, −40° C. to +60° C.

In contrast to the method of operation as explained above, the opposite effect occurs when the temperature falls. This is because the resonant frequency would intrinsically rise, for example, when the temperature falls. However, the bimetallic strip is deformed toward the inner conductor (assuming that it is likewise once again attached to the inner face of the cover of the resonator), thus increasing the head capacitance. This once again leads to the desired compensation and stabilization of the resonant frequency.

Finally, the optimum setting of the compensation effect can be influenced and varied by choice of the materials and metals for the bimetallic effect, by the size and/or shape of this bimetallic adjusting element, by the alignment in the interior of the radio-frequency resonator and by the positioning and location in the interior of the resonator. Positioning in particular in the area of high electrical field strengths leads to an increase in the effect. In this case, it is possible to use physically smaller bimetallic adjusting elements and/or compensation devices.

Finally, even overcompensation or undercompensation can be achieved within the scope of the intention, if this is desirable.

The advantage of the solution according to the invention is not only simplicity but also in particular that, in principle, it allows a compensation capability for those resonator types in which, otherwise, no compensation whatsoever has until now been possible, in some cases, owing to the mechanical characteristics of the individual resonators, even if, for example, the inner conductor were to have been produced completely from high-alloy steel on the basis of the prior art in this generic field.

Further advantages, details and features of the invention will become evident from the exemplary embodiments in the following text, which are illustrated on the basis of drawings, in which, in detail:

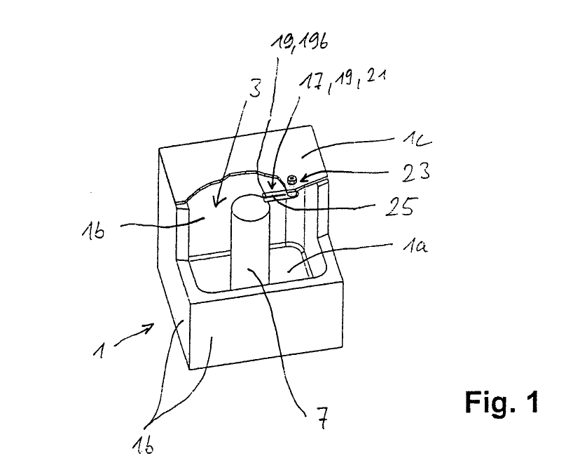

FIG. 1: shows a schematic perspective illustration of a coaxial radio-frequency resonator according to the invention (partially in the cutaway state), using an adjusting and compensation device according to the invention;

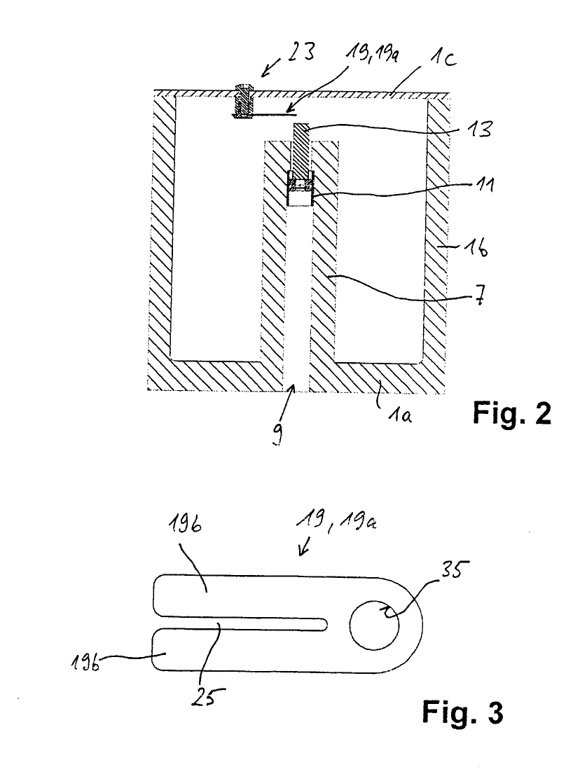

FIG. 2: shows a schematic axial cross-section illustration through the RF resonator shown in FIG. 1;

FIG. 3: shows a plan view of a first exemplary embodiment of the stabilization and compensation device according to the invention;

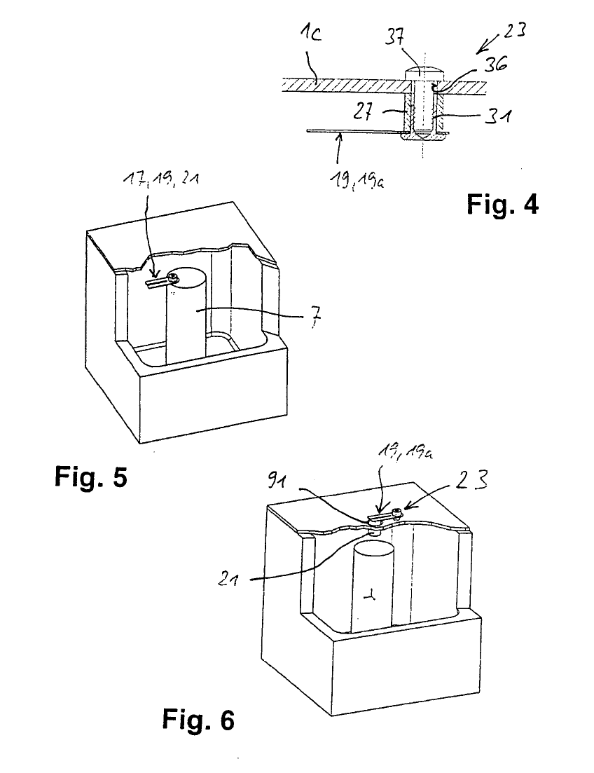

FIG. 4: shows a schematic cross-section illustration in order to illustrate an attachment device for the adjusting and compensation device according to the invention;

FIG. 5: shows a further exemplary embodiment of the invention in the form of a schematic perspective illustration in contrast to FIG. 1, in which the adjusting and compensation device according to the invention is attached to the inner conductor; and

FIG. 6: shows another different perspective illustration of an exemplary embodiment according to the invention in which the bimetallic adjusting device is attached to and mounted on the outside of the radio-frequency resonator, specifically on the upper face of the cover, and the associated compensation device, which is operated via the adjusting device, is arranged in the interior of the radio-frequency resonator.

FIG. 1 shows a first exemplary embodiment of the invention. For this purpose, FIG. 1 shows a coaxial radio-frequency resonator, which is partially illustrated in the cutaway position. This coaxial radio-frequency resonator has a housing 1, which in some cases is also referred to in the following text as the outer conductor housing 1. This housing 1 has a housing base 1a on whose circumferential edge a running housing wall 1b is raised, running transversely with respect to the housing base 1a and running at right angles to it in the illustrated exemplary embodiment.

The housing 1 defines a housing interior 3. The upper face of the housing 1 is closed by a so-called housing cover 1c. In principle, the separating surface between the housing cover and the surrounding housing may also be provided elsewhere, for example in such a way that the housing cover likewise has a partially surrounding wall 1b, so that the housing 1 has a separating surface on a plane between the cover 1c and the base 1a. The separating line can likewise also be provided at the bottom in the area of the plane of the housing base 1a, so that the housing cover is placed on the flat housing base 1a effectively in the form of a cap with surrounding housing walls 1b.

As can also be seen, the RF resonator has an inner conductor 7 which, in the illustrated exemplary embodiment, is cylindrical and extends upward at right angles to the housing base 1a. The cylindrical inner conductor 7 that is formed in this way is preferably integrally connected to the housing base 1a. However, the inner conductor may also in contrast be cylindrical or hollow-cylindrical. The internal cross-section surface at right angles to the inner conductor also need not necessarily be square. It may also be circular or may have a polygonal cross section. In the illustrated exemplary embodiment, the corner areas are also round internally on the inside.

As can be seen from the cross-section illustration shown in FIG. 2, a corresponding hole or an opening 9 is normally provided in an axial extension of the inner conductor 7 in the housing base 1a, via which an adjusting element 11 that is provided with an external thread can be screwed in and out at least over a certain axial distance. A dielectric adjusting element 13 is normally seated in an axial extension on this adjusting element 11 and can project to a certain extent at the upper end of the inner conductor 7, which ends at an axial distance from the lower face of the housing cover 1c. Rotation of the adjusting element 11 varies the projection height of the dielectric adjusting element 13, thus in principle making it possible to set or preset a desired resonator frequency. In this context, reference should be made to known prior publications.

An RF resonator formed in this way is now provided with a stabilization and/or compensation device 17 which has an adjusting device 19 and a capacitance changing device 21.

In the illustrated exemplary embodiment, an adjusting device 19 in the exemplary embodiment shown in FIG. 1 is arranged and positioned on the lower face of the housing cover 1c parallel and at a distance from it in the interior of the housing 1 via an intermodulation-compatible holding system 23, which is also described in greater detail in the following text. In the illustrated exemplary embodiment shown in FIGS. 1 to 3, this adjusting device 19 comprises a bimetallic element 19a which is composed of at least two different metals with different coefficients of expansion, which are arranged flat or in layers one on top of the other (FIG. 3). The material thus has the capability to vary its shape as a function of the temperature. In this case, the bimetallic element 19a is preferably in the form of strips or is in the form of two or more strips, with the transverse extent of these bimetallic strips preferably being 15% or less with respect to its longitudinal direction, in order to ensure optimum temperature-dependent deformation and curvature of the bimetallic strip or element.

In the illustrated exemplary embodiment, the at least approximately rectangular bimetallic element is for this purpose provided with a slot 25 which runs from one side virtually to the opposite side, thus producing two bimetallic strips 19b.

This bimetallic element 19a is arranged in the area of high electrical field strengths and in this case, in a side view, is located between the area of the upper end of the inner conductor 7 and the lower face of the housing cover 1c. Viewed in a plan view, the free ends of the bimetallic element 19b end in the area of the hollow-cylindrical inner conductor 7 which means that, in a plan view, they can at least partially cover this inner conductor 7.

The bimetallic element is arranged and selected (with respect to the location of its temperature-dependent different metal layers) such that, when a temperature increase occurs, the adjusting device 19 which comprises a bimetallic element or is similar to a bimetallic strip is deformed toward the housing cover 1c so that the electrical field lines which run from the inner conductor 7 toward the adjusting device 19, which is in the form of or is similar to a bimetallic strip, have to overcome a greater distance, so that the so-called head capacitance decreases. This effect compensates for the opposite effect of thermal expansion, so that the resonator oscillates at the same resonator frequency independently of the temperature. The opposite effect occurs when the temperature falls. In this case, the bimetallic element will be deformed in the direction of the inner conductor 7, as a result of which the head capacitance becomes greater, with this effect likewise compensating once again for the temperature-dependent effect, so that the resonator frequency remains the same.

The bimetallic adjusting element may in this case have any desired shapes over wide ranges. It may have only one element in the form of a strip or two or more elements in the form of strips, which are separated by way of example by slots. These elements may be made physically larger, that is to say longer than in the illustrated exemplary embodiment. They may also be made physically shorter. The bimetallic element may in this case also be designed like a comb and may have a large number of deformable adjusting sections in the form of strips. In this case, the compensation effect being exerted by the bimetallic adjusting element may be adapted by appropriate choice of the materials of the two interacting metals which produce the deformation, by their size, thickness and in particular also by their alignment (for example parallel to the cover or running at an angle to it) and in particular by the positioning in the interior 3 of the resonator, such that the desired exact temperature-dependent compensation is achieved, so that the resonator frequency remains constant over a wide temperature range from, for example, −40° C. to +60° C. If required, undercompensation or overcompensation may even be provided if this is desirable.

The fairly flat bimetallic element should preferably be aligned such that it runs transversely with respect to the inner conductor 7 or parallel to the cover or base. The compensation effect decreases as the alignment angle increases, that is to say the angle to the cover or to the housing base. The alignment of the bimetallic strip should therefore preferably not exceed an angle of 45° to the housing cover or housing base.

An element which is similar to a bimetallic strip may also be used as the bimetallic element, having not just two but more layers, in particular metal layers, for example also with a metallic intermediate layer between the two metal layers which produce the deformation. Finally, the bimetallic adjusting element may also be provided with a conductive and nonconductive coating layer, for example of silver. This ensures that the currents which occur in the radio-frequency GHz range cannot penetrate into the actual bimetallic element, thus minimizing power losses.

The layer thicknesses for a conductive surface layer for the bimetallic element may, for example, be less than 100 μm, in particular less than 50 μm, or, for example, around 30 μm. Layer thicknesses around 10 μm are adequate. Values of more than 1 μm, in particular of more than 4 μm or 8 μm, may be considered as possible lower limits.

The expression bimetallic strip or element which is similar to a bimetallic strip for the purposes of the present application also covers those adjusting devices which are curved or vary their position as a function of temperature and which, by way of example, are formed from nonmetallic or nonelectrically conductive two-layer or multiple-layer arrangements. In particular in this case, dielectric or electrically conductive material must then in fact be used or additionally provided which assumes a temperature-dependent different position as a result of the effect that is similar to that of a bimetallic strip, thus contributing to the desired stabilization of the resonant frequency.

As is also evident from the exemplary embodiments that have been explained so far, the adjusting device 19 which is in the form of or is similar to a bimetallic strip and the capacitance changing device 21 represent and form the same component.

This is because the bimetallic deformation effect results in a position change and the metallic form of this temperature-dependent bimetallic adjusting device, or adjusting device which is similar to a bimetallic strip, at the same time results in a capacitance change, so that the resonant frequency can be kept constant independently of the temperature. As will also be described later, however, the adjusting device 19 which is in the form of or is similar to a bimetallic strip and the capacitance changing device 21 may also be formed by two separate components or at least two components or component sections which are connected to one another.

FIG. 4 shows a schematic cross section of an intermodulation-compatible or intermodulation-free holding system 73.

As can be seen from this figure, a spacing sleeve 27 is used, for example, on which the adjusting element 19 which is in the form of or is similar to a bimetallic strip is placed with its holding hole. The adjusting element 19, which is in the form of a leaf and is in the form of a bimetallic strip, is thus held via a holding bolt 31 that is provided with a threaded cap 33, with the holding bolt 31 passing through a hole 35 in the adjusting element 19 that is in the form of a bimetallic strip, and engaging in the corresponding hole in the spacing sleeve 27. A further hole 36 is incorporated in the housing cover 1c in an arrangement that is axially aligned with this, so that the external thread of an attachment screw 37, which is screwed in from the outside, can be screwed into the corresponding internal thread in the hollow-cylindrical holding bolt 31, thus fixing the entire arrangement firmly to the housing cover 1c and/or to the housing 1.

The parts which are used for fixing may all be electrically conductive, thus resulting in an electrically conductive connection between the housing cover and the adjusting element 19 which is in the form of a bimetallic strip. However, the corresponding attachment may also be produced in a nonelectrically conductive arrangement, for example by the spacing sleeve and, for example, the holding bolt 31 being composed of electrically nonconductive, dielectric material. As an alternative to the holding bolt, the threaded screw may also be formed from nonconductive material. In this case, this results in a capacitive link between the bimetallic element and the housing cover.

The purpose of FIG. 5 is only to show that the adjusting element 19 which is in the form of a bimetallic strip and has been explained can also be attached, for example, by its attachment section to the material circumference, for example to the upper end face of the inner conductor 7 using a screw. In the exemplary embodiment illustrated in FIG. 4, the free-end sections, which are in the form of bimetallic strips, of the adjusting element which is in the form of a bimetallic strip project away from the inner conductor.

Thus, in the exemplary embodiments which have been explained, the stabilization and/or compensation device 17 has been formed by an adjusting element 19 which is in the form of or is similar to a bimetallic strip and at the same time also represents the capacitance changing device 21, because the bimetallic element is itself conductive, or is additionally or alternatively covered with a conductive or nonconductive dielectric layer. In the same way, however, a separate capacitance changing device 21 could be provided or formed on the bimetallic adjusting element which is formed in this way and may possibly be attached at a different point, for example to a housing side wall, preferably at its free end whose position changes as a result of the change in the temperature. This separate capacitance changing device 21 may be formed, for example, from a small metal plate or from bodies, layers or the like of other shapes, which are provided or formed on, or are at least attached to, the end of the bimetallic element. The arrangement in the interior 3 of the RF resonator is preferably once again in an area with a high electrical field strength, that is to say preferably in the area between the upper end of the inner conductor and the lower face of the housing cover.

FIG. 6 will now be used to show that the adjusting device 19 may also be arranged and designed in a split manner using the bimetallic element 19a and the capacitance changing device 21, such that the adjusting element 19 which is in the form of a bimetallic strip is arranged outside the resonator, and the capacitance changing device 21 is arranged inside the resonator.

In the exemplary embodiment shown in FIG. 6, a bimetallic element 19a as has been explained with reference to the previous exemplary embodiments is attached to the upper face of the housing cover 1c for this purpose in an appropriate manner by means of the preferably intermodulation-compatible holding system 23. A corresponding hole 91 is provided in the housing cover 1c in the area of the free end of the bimetallic element 19a. A capacitance changing device 21, which is cylindrical in the illustrated exemplary embodiment, projects through this hole by a certain axial distance beyond the lower face or inner face of the housing cover 1c in the direction of the inner conductor 7. When an appropriate temperature change occurs, the bimetallic element which is provided on the outside of the resonator is now deformed, so that the lower height of the cylindrical capacitance changing device 21 likewise experiences a change in its height position, so that the distance to the inner conductor 7 which is located underneath it thus changes, resulting in this way in the desired temperature compensation.

In this exemplary embodiment as well, the capacitance changing device 21 may be composed of an electrically conductive or dielectric element. Combined embodiments are also possible, in which the capacitance changing device 21 has dielectric sections or electrically conductive sections.

In principle, the bimetallic adjusting device 19, or the adjusting device 19 which is in the form of or is similar to a bimetallic strip, can be fitted and attached at all conceivable points within the resonator. However, since the electrical field strengths within the resonator decrease towards the base, fitting of the element and in particular positioning of the capacitance changing device 21 in this area results in only a more minor change. Alignment of the bimetallic element at least with one component in the axial direction of the inner conductor 7 would likewise also result in the temperature-dependent bimetallic effect producing a more minor influence and change in the electrical field, and would thus lead to a reduced compensation effect.

The invention has been explained with reference to a coaxial single-circuit radio-frequency filter. Filters such as these are normally connected together to form multiple radio-frequency filters or so-called coaxial radio-frequency resonators, and have at least one input and one output. However, they may likewise also be connected together, for example, to form a radio-frequency diplexer as is also known, for example, from DE 103 20 620 B3 or, for example, U.S. Pat. No. 6,392,506 B2. When filters or resonators such as these are connected together, at least one resonator in the transmission path has a capacitive and/or inductive input coupling and at least one other resonator has a capacitive and/or inductive output coupling, via which a signal can be respectively injected and emitted again. The individual resonators in this case have apertures, so-called coupling openings, in the coupling walls, which define the electromagnetic signal path. In this context, reference should be made to the known embodiments.

1. A coaxial radio-frequency resonator comprising:
an outer conductor and/or an outer conductor housing, having a housing base, having a housing cover and having housing walls which run between the housing base and the housing cover,
an inner conductors which runs axially within the resonator, is raised running from the housing base in the direction of the housing cover and ends at a distance before it,
a stabilization and/or compensation device for temperature-independent stabilization of a preselected, preset or predetermined resonator frequency, the stabilization and/or compensation device having a device which is in the form of or is similar to a bimetallic strip that deforms as a function of temperature, and
the stabilization and/or compensation device has and/or is fitted directly or indirectly with a capacitance changing device, which has at least one electrically conductive section, at least one dielectric section or at least both, and
the capacitance changing device is arranged in the interior of the resonator.

2. The RF resonator according to claim 1, wherein the adjusting device, which is in the form of or is similar to a bimetallic strip, has at least two metal or material layers with different coefficients of expansion.

3. The RF resonator according to claim 1, wherein the adjusting device which is in the form of or is similar to a bimetallic strip has a transverse extent, or individual sections having a transverse extent, which is less than 15% and in particular less than 10% of the associated longitudinal extent of the adjusting device, which is in the form of or is similar to a bimetallic strip, or of the individual associated sections.

4. The RF resonator according to claims 1, wherein the adjusting element has additional intermediate and/or external layers.

5. The RF resonator according to claim 4, characterized in wherein the adjusting device has at least one conductive external layer, for example composed of silver.

6. The RF resonator according to claim 5, wherein the external layer has a thickness of less than 50 μm, in particular of less than 30 μm and preferably of more than 1 μm, in particular of more than 4 μm or 8 μm and in particular of around 10 μm.

7. The RF resonator according to claim 1, wherein the capacitance changing device comprises or has the adjusting device which is similar to or is in the form of a bimetallic strip.

8. The RF resonator according to claims 1, wherein the adjusting device which is in the form of or is similar to a bimetallic strip is arranged outside the RF resonator, in that the capacitance changing device is arranged in the interiors of the RF resonators, and in that the capacitance changing device is held directly or indirectly with the adjusting device such that it passes through a hole or opening in the housing of the RF resonator.

9. The RF resonator according to claim 1, wherein the capacitance changing device is arranged in the area of high electrical fields in the interior of the housing.

10. The RF resonator according to claim 10, characterized in wherein the capacitance changing devices and, preferably, the adjusting device are arranged in the space between the upper end of the inner conductors and the lower face of the housing cover.

11. The RF resonator according to claim 1, wherein the capacitance changing device and/or the adjusting device which is in the form of or is similar to a bimetallic strip are/is aligned parallel to the housing cover or preferably with a component parallel to the housing cover which is greater than the component running at right angles to the housing cover.

12. The RF resonator according to claim 1, wherein the adjusting device which is in the form of or is similar to a bimetallic strip has at least one longitudinal slot (19a), which forms at least two individually deformable sections.

13. The RF resonator according to claim 1, wherein the adjusting device which is in the form of or is similar to a bimetallic strip has a thickness which is less than 1 mm, and in particular is less than 0.8 mm.

14. The RF resonator according to one of claim 1, wherein the stabilization and/or compensation device is attached or is mounted in, and is held on or in the housing of the RF resonator by means of an intermodulation-compatible holding systems.

15. The RF resonator according to claim 14, characterized in wherein the holding system has a sleeve which is arranged as a spacer between a housing inner face of the RF resonator and the adjusting element which is in the form of or is similar to a bimetallic strip, and the adjusting element is anchored via a threaded bolt which is provided with an internal thread and via a screw which engages in it, which pass through the spacers and are supported opposite on the housing and/or on the adjusting element.

16. The RF resonator according to claim 15, wherein the holding system is electrically/galvanically conductive.

17. The RF resonator according to claim 14, wherein the holding system is composed at least partially of insulating materials and/or dielectric materials, and the adjusting element and/or the capacitance changing device are/is attached capacitively, that is to say such that it is electrically/galvanically isolated from the housing and/or from the inner conductor.

18. The RF resonator according to claims 1, wherein two or more RF resonators are connected together to form an overall resonator or an RF frequency diplexer.
